(19) United States
(12) Patent Application Publication
(10) Pub. No.: US 2019/0186173 A1
(43) Pub. Date: Jun. 20, 2019

(54) SECURED STORAGE SPACE SYSTEM WITH LOCKING COMPONENT

(71) Applicant: Anthony Johnson, Fayetteville, GA (US)

(72) Inventor: Anthony Johnson, Fayetteville, GA (US)

(21) Appl. No.: 16/224,114

(22) Filed: Dec. 18, 2018

Related U.S. Application Data
(60) Provisional application No. 62/608,369, filed on Dec. 20, 2017.

(51) Int. Cl. E05B 65/44; A47B 77/02; A47B 67/02

(52) U.S. Cl. CPC E05B 65/44; A47B 77/02; A47B 2067/025; E05Y 2900/20; A47B 67/02

(57) ABSTRACT

A storage space door with means for creating a secured lock(able) space in the bottom portion of a cabinet box using an existing shelf is disclosed, In one embodiment, a two piece lockable cabinet door allows the doors to open and close separately and only the bottom portion of the two piece door locks, allowing a user to safely lock away all personal or dangerous items while leaving the top portion of the cabinet box fully accessible for normal storage and use.

### RELATED APPLICATION

This application claims priority to U.S. Provisional Application Ser. No. 62/608,369 filed Dec. 20, 2017 entitled “Two piece cabinet door with means for creating a secured lock(able) space in the bottom portion of a kitchen cabinet box using the existing shelf,” which is hereby incorporated by reference in its entirety.

### BACKGROUND

Storage spaces are typically highly used either at home, in the workplace, or elsewhere. As an example of one type of storage space, cabinets are highly used in homes and workplaces for storages. Many cabinet users typically have a need to store at least one secured item in their cabinet space and require a locking mechanism to ensure the storage. However, the secured items such as personal or hazardous items like pharmaceuticals, money, heirlooms, or collectables, are typically of a small volume compared to the total volume of the cabinet. Typical cabinet storage embodiments require a locking mechanism placed on an existing cabinet door to make it into a secured space capable of storing secured items. However, this makes the entire cabinet box, or other storage space, inaccessible for storing non-secured items. This is particularly problematic when a storage space is in a space or structure that is highly used for regular or daily activities, such as a cabinet box in a kitchen. This creates an inefficient usage of cabinet or other storage space because secured items are typically small in volume compared to the available cabinet or storage space that is behind a typical locking mechanism. Further, in a typical household adults may store pharmaceuticals in a kitchen or other unlockable cabinet or portion of a cabinet for storage and in some cases for regular use. Such storage permits people who are not authorized to handle or use the pharmaceuticals to improperly possess them. Such stealing may occur by visitors, or by relatives, and is increasingly occurring with prescription opioids and narcotics in the United States. Homes today are normally not furnished with medicine cabinets in the bathrooms anymore, or in many cases even if there are such medicine cabinets they are not lockable. Therefore, many people leave their pharmaceuticals under a sink, in a drawer, on the bathroom counter, in a non-lockable cabinet in the kitchen, or otherwise out in the open and unsecured. Children and adults can steal these drugs very easily because they are normally not locked up and may be in visible or easily visible locations. In some cases, individuals may identify where pharmaceuticals are located and steal a small portion of the pharmaceuticals, e.g., one or two pills at a time, so that the theft goes unnoticed. Thus, there is a need for a system that will allow users to lock a portion of a storage space where they would typically but to still be able to use any remaining storage space.

### SUMMARY

The following presents a simplified summary of the invention in order to provide a basic understanding of some aspects of the invention. This summary is not an extensive overview of the invention and is not intended to be limiting in scope nor exhaustive in breath. It is not intended to identify key or critical elements of the invention or to delineate the scope of the invention; its sole purpose is to present concepts of the invention in a simplified form as a prelude to the more detailed description that is subsequently presented.

In certain embodiments of the invention, a cabinet is located in a room comprising a secure storage space with six barriers comprising: a cabinet door, a cabinet shelf forming a ceiling, a cabinet frame forming a floor and three sides. The cabinet door has a first selected vertical height, is installed after the installation of the cabinet in the room, and comprises a first durable material and a locking mechanism. Further, an unsecure storage space with six barriers is included in certain embodiments comprising: a second cabinet door, the cabinet shelf forming a floor, and the cabinet frame forming a ceiling and three sides. This second cabinet door has a second selected vertical height, was installed at about the same time as the installation of the cabinet in the room, and comprises a second durable material. In certain embodiments, the cabinet door and the second cabinet door share a pattern, the contents of the secure storage space comprise at least one item that is at least either significantly valuable or significantly hazardous, and the contents of the unsecure storage space consist of items that are neither significantly valuable nor significantly hazardous.

In further embodiments, the cabinet has a cabinet door comprising an affixed knob near the locking mechanism. The cabinet locking mechanism comprises steel and is operable by a metal key. Further, the top of the cabinet door and the bottom of the second cabinet door may be separated by a gap of between 1 mm and 10 mm, and the pattern may be incongruent with respect to the gap. The cabinet shelf may also be installed at about the same time as the installation of the cabinet in the room. Further, the first durable material may be a hardwood, and that hardwood may be solid oak. In other embodiments, the cabinet shelf consists of material with a greater density than oak, and in still further embodiments the first durable material has a greater density than the second durable material.

In certain embodiments, the cabinet further comprises at least one steel hinge affixed to the cabinet door, and at least one steel hinge may have a greater durability than any other hinge affixed to the cabinet. The unsecure storage space may contain items used for the regular functioning of the room. In other embodiments, the cabinet has a first selected vertical height which is at least about 3 inches and the second selected vertical height is at least about twice the height of the first selected vertical height. In still other embodiments, the first selected vertical height is about 6 inches, and the second selected vertical height is at least about 18 inches.

In further embodiments, the present invention contemplates a cabinet in a kitchen comprising: a secure storage space with six barriers comprising: a first wooden cabinet door, a wooden cabinet shelf forming a ceiling, and a wooden cabinet frame forming a floor and three sides. The first wooden cabinet door has a vertical dimension of about 6 inches, is installed after the installation of the cabinet in the kitchen, and comprises a metal locking mechanism, and either a knob or handle near the locking mechanism. Further, the cabinet may have an unsecure storage space with six barriers comprising: a second wooden cabinet door, the wooden cabinet shelf forming a floor, and the wooden cabinet frame forming a ceiling and three sides. The second wooden cabinet door has a second selected vertical height, is installed after the installation of the cabinet in the kitchen, and comprises a second knob or handle. In some embodiments of the present invention, the contents of the secure storage space comprise at least one item that is at least either significantly valuable or significantly hazardous. In some embodiments, the first wooden cabinet door and the second wooden cabinet door are separated by a gap of around 3 mm, share a pattern that is incongruent with respect to the gap, and comprise at least the same paint and molding pattern. In still other embodiments, the contents of the secure storage space comprise prescription medications and over-the-counter medications, and the contents of the unsecure storage space consist of items useful for the regular use of a kitchen. In still other embodiments, the contents of the secure storage space may also comprise prescription medications, over-the-counter medications, and vitamins. In still other embodiments, the contents of the unsecure storage space may comprise plateware, the knob or handle and the second knob or handle may be made of metal, the second selected vertical height may be at least about 12 inches, and the first wooden cabinet door and the second wooden cabinet door are made of oak.

In a further embodiment of the invention, a method of installation, selection, and/or construction is contemplated. A method of installing a secure storage space door on an existing kitchen cabinet in a family household comprises selecting a kitchen cabinet in a family household having at least one existing shelf where the bottom of a frame of the kitchen cabinet is located at least three feet above a kitchen floor; removing a door from the kitchen cabinet; removing at least one hinge from the kitchen cabinet; selecting a flat piece of a durable material in about the same dimensions as the door; selecting a height for a secured storage space where the height is less than half of the vertical dimension of the door, and affixing the shelf to the frame where the bottom of the shelf is at the selected height; creating a pattern on the having four edges that are near the four edges of the piece, which may be incongruent with the selected height, and may also comprises molding, a color, and a selection of matte or gloss matching existing nearby kitchen cabinetry; cutting the piece at said height and retaining a shorter piece and a longer piece; restoring any blemish affecting the pattern following the cutting; affixing a metal locking mechanism to the bottom of the cabinet; affixing at least one steel hinge on a frame of said cabinet; affixing the shorter piece to said at least one steel hinge; affixing the longer piece to at least one hinge on the frame, where said longer piece is mounted to create a gap between the two piece of between about 1 mm to 5 mm. Further embodiments of the method may change the order of the installation steps to create increased efficiencies.

In still further embodiments, in the above method the height may be between about 3 inches and about 6 inches, the durable material may be a hardwood; and such piece may be selected by measuring and cutting a piece of hardwood larger than the door. In further embodiments, the locking mechanism comprises steel or any metal alloy. In still other embodiments, the shorter piece is affixed vertically below the longer piece, the gap is about 3 mm, and the molding comprises a wood composite affixed to the piece.

Further features of the present invention will be apparent from the description that follows. After review, such features may, in part, be obvious from the description or may be learned by practice of the invention. It is to be understood that both the foregoing general description and the following detailed description are exemplary and explanatory only and are not restrictive of the invention, as claimed.

### BRIEF DESCRIPTION OF THE FIGURES

FIG. 1 illustrates a kitchen cabinet door embodiment of the invention having two doors which are both closed.

FIG. 2 illustrates a kitchen cabinet door embodiment of the invention having two doors which are both open.

FIG. 3 illustrates a kitchen cabinet door embodiment of the invention having two doors wherein a top door is open.

FIG. 4 illustrates a kitchen cabinet door embodiment of the invention having two doors wherein a bottom door is open.

FIG. 5 illustrates a method chart of an installation of a kitchen cabinet door embodiment of the invention.

### DETAILED DESCRIPTION OF FIGURES AND EMBODIMENTS

Having generally summarized the invention disclosure above, a further understanding can be obtained by reference to certain specific examples illustrated below which are provided for purposes of illustration only and are not intended to be all inclusive or limiting unless otherwise specified. Accordingly, term or phrases such as “for example” or “e.g.” and the like, even if they are not coupled with a modifier such as “without limitation” or the like, are not intended to be limiting of the disclosure of the invention.

Reference now will be made in detail to embodiments and examples of the present invention. The particular components and amounts thereof recited in these examples, as well as other conditions and details, should not be construed to unduly limit this invention.

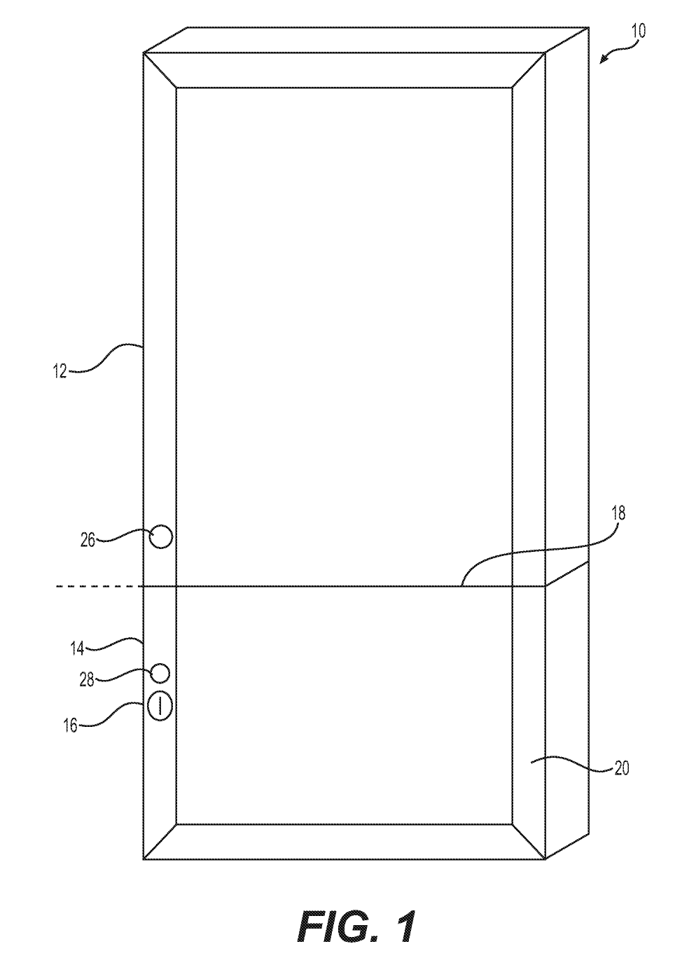

FIG. 1 illustrates an embodiment of the secured storage space system that is a two-piece lockable cabinet door 10. A top door portion 12 is a depicted as well as a bottom door portion 14. In this embodiment, the cabinet doors may open and close separately. Only the bottom portion 14of the two-piece cabinet door 10 locks, allowing a user to safely lock away a portion of, or preferably all personal or dangerous items while leaving the top portion of the cabinet, i.e., non-secured storage space, accessible for normal storage and use. A key entry for a lock 16 permits a user to activate a locking mechanism to either lock or unlock only the bottom portion of the cabinet to permit access to the secured space. A separation gap 18 is illustrated between the two cabinet door portions 12, 14. The gap 18 may be just large enough to permit the doors 12, 14 to open without touching each other, and may not be so large that it permits access to the secured space. In typical embodiments, the gap 18 is very small and achievable in the carpentry arts so that the doors 12, 14 do not appear to be separate. In certain embodiments the gap is between 1.0 mm and 10 mm. In other embodiments, the gap 18 would be on a medicine cabinet, and would be very small to permit continuity between mirrors that would be on each of the doors. A pattern 20 covers the top of the cabinet doors 12, 14. The pattern 20 in FIG. 1 is moulding and is designed to surround each door 12, 14 so that the doors 12, 14 appear to be a single cabinet door. Other patterns are contemplated, and for improved security such patterns are incongruent or not matching, adhering to, identifying, or highlighting the gap, optional handles, or presence of either. The top and bottom portions of the door 12, 14 may each have a handle 26, 28 to facilitate a user opening and closing the door. In a typical embodiment, users may safely lock away all personal or dangerous items while leaving the top portion of the cabinet box fully accessible for normal kitchen storage and use.

Other embodiments are contemplated for the invention. For example, the key entry lock 16 could also be placed underneath or on the side of the cabinet door 14, or in some other position that would be less visible during everyday usage, yet still reasonably accessible for a user to access it with a key. Typically, the key entry lock would be used with a metal key to lock or unlock it, but other materials and types of keys are contemplated. Electronic locks and keys, including those using Bluetooth or other nearfield technology, or Wi-Fi are also contemplated. In a typical embodiment, the secured storage space system would be installed in a kitchen. The pattern 20 would match existing patterns other storage of a similar type on the same space, e.g., if the secured space storage system was in a kitchen cabinet where the other kitchen cabinets had a particular moulding pattern, then the pattern 20 would match those of the existing kitchen cabinets. This can permit a greater degree of inconspicuousness of the location, or presence of personal, valuable or hazardous objects that may be placed inside the secured storage space.

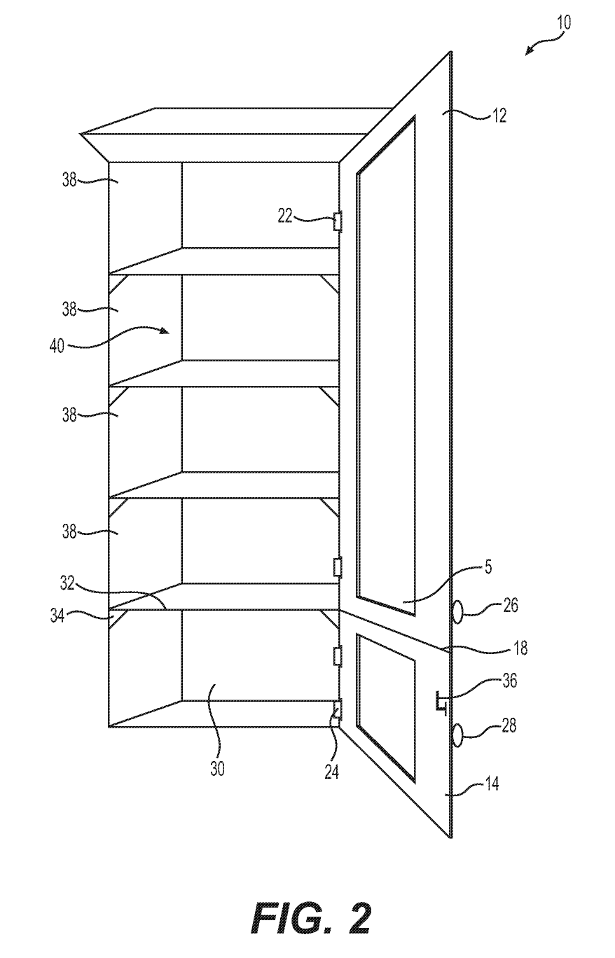

FIG. 2 illustrates an embodiment of the secured storage space system that is a two-piece lockable cabinet door 10. In this depiction, the top door 12 and bottom door 14 are both swung open. Each door also has a handle 26, 28 to facilitate a user opening and closing the door. The opposite side of a key entry lock is depicted as a locking mechanism 36. This particular embodied locking mechanism would rotate with the turn of a key when the bottom portion of the door 14 is closed and would latch to a portion of the secured storage space 30 thereby locking the space 30. A shelf 32 is also depicted in FIG. 2 which here serves as the ceiling of the secured storage space 30, and also as the floor of a non-secured storage space 38. A plurality of non-secured storage spaces 38 are depicted, although the present invention would have at least one such non-secured storage space 38. A shelf support 34 keeps the shelf 32 raised at least to define the secured space 30 versus the non-secured space(s) 38. A cabinet box 40 may be a single piece defining the back of the secured space 30 and also the back of the non-secured space(s) 38. In typical residential kitchen embodiments it would be expected that the cabinet box 40 would be a single piece of wood. At least one hinge 22 for the top portion of the door 12 is depicted to permit the door 12 to open and close. Additionally, at least one hinge 24 for the bottom portion of the door 14 is depicted to permit the door 14 to open and close. If the secure space door 14 is broken or pried open, it will be noticed immediately that the drugs have been tampered with or at least the attempt was made to tamper with them. This will also allow parents time to address and or correct any illegal usage or selling of the drugs opposed to not knowing it's happening for extended periods of time.

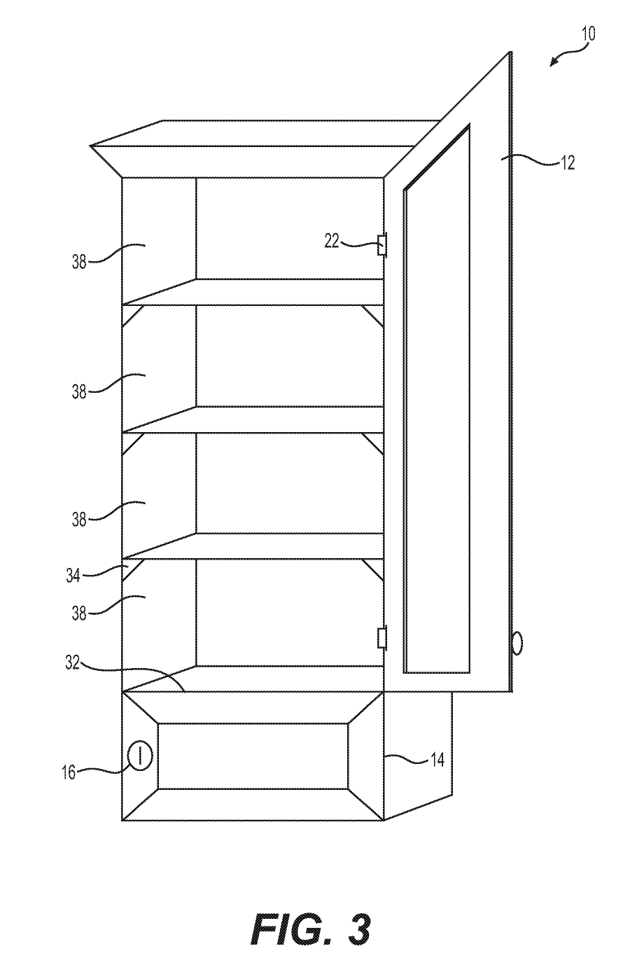

FIG. 3 illustrates an embodiment of the secured storage space system that is a two-piece lockable cabinet door 10. In this illustration, the top door portion 12 is open, while the separate bottom door portion 14 is closed in a lockable position. The key entry 16 is depicted, as is the shelf 32 that forms the ceiling of the secured space 30 and the floor of the non-secured space(s) 38.

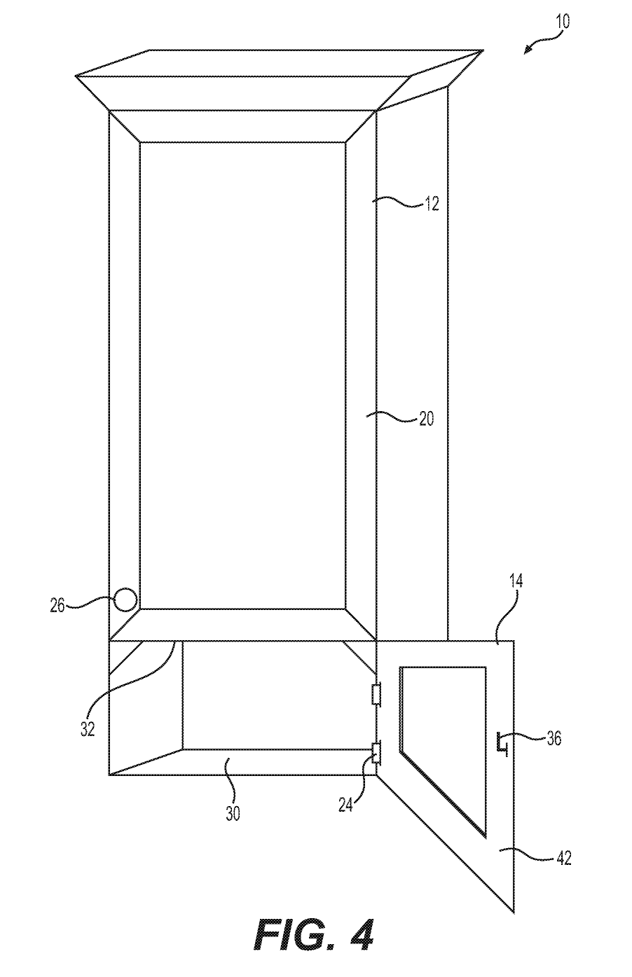

FIG. 4 illustrates an embodiment of the secured storage space system that is a two-piece lockable cabinet door 10. The top portion of the door 12 is closed, and the bottom portion of the door 14 is open, resting on at least one hinge 24, and permitting access to the secured space 30. The locking mechanism 36 is depicted in an open orientation. The bottom portion of the shelf 32 is depicted forming the ceiling of the secured space 30. In this particular embodiment, the pattern 20 is contained only on the top portion of the door 12, although there is a matching but separate pattern 42 on the bottom portion of the door 14. In other embodiments, the key entry 16 and locking mechanism 36 may be affixed to the cabinet box or body in the open configuration, and upon being locked the locking mechanism 36 would engage with and prevent a closed door portion 14 from opening. Such an embodiment would enable the key entry 16 and locking mechanism 36 to be placed in more inconspicuous locations such as on the side or underneath the cabinet box.

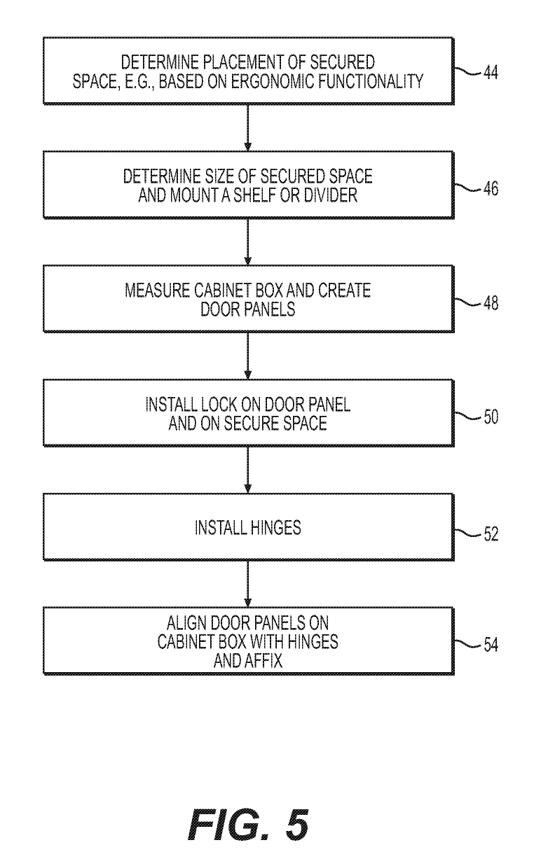

FIG. 5 illustrates a method chart of an installation of a kitchen cabinet door embodiment of the invention. Typically, this method would be employed by one installing an embodiment of the invention in a house or office such as a home developer, carpenter, general contractor, subcontractor, kitchen remodeler, handyman, homeowner, or any agents thereof or others having basic carpentry skills.

First, an individual would determine the placement of the secured space based on ergonomic functionality for either or both of the expected user 44, and/or the individual or type of individual expected to be at risk of improper possession. For example, the secure space door can be installed on high cabinets which would be helpful in keeping it away from children, or it could be installed on lower cabinets, which would be helpful for shorter people to reach. An installation on lower cabinets may be helpful and preferable for elderly people, people in wheelchairs, or disabled individuals that would need the secure space door to be more handicapped accessible. Typically, the invention would be installed by selecting the height of the secure storage space and accompanying knob on the secure storage space door at an arm-reachable length for an intended user. For typical elderly users, a height of between 3.5 feet and 7.0 feet is preferred, although it may vary depending on the height of an individual intending to use it. For shorter adults who would prefer placement above eye-level, a height of between 5.5 feet and 7.0 feet is preferred. For tall individuals who are over 6 feet tall who prefer placement above eye level, a height of between 6.5 feet and 8.5 feet height is preferred. For certain elderly users and handicapped users, placement at around 3.5 feet to around 5.0 feet is preferred so that minimal reaching is needed. Generally, an embodiment of the present inventive secured storage space would be installed in an existing kitchen cabinet at between 2.0 feet to 8.0 feet, and would especially be installed in an existing kitchen cabinet at between 4.0 feet and 6.0 feet, and would be most preferably installed at between 5.0 feet and 6.0 feet.

Second, an individual would determine the size of the secured space and mount a shelf or divider 46. In a typical embodiment this would be an existing shelf or divider, whether horizontal or vertical, that is already present in the cabinet or kit to make the cabinet.

Third, an individual would measure the cabinet box and create door panels 48 for as many door portions as there are for the secured and non-secured spaces. In a typical embodiment, there would be one door panel for a secured space door, and one door panel for non-secured space door, e.g., a bottom door portion and top door portion. Typically, the door panels would be made of wood, or wood composite products and cut to the measurements of the cabinet box.

Fourth, an individual would install the lock on the door panel that would be used to cover the secured space 50, and would install any needed accompanying door lock component on or in the secured space.

Fifth, an individual would install at least one hinge 52 for each and every door panel portion onto the cabinet box. In a typical embodiment, this would be one hinge on the top door portion, and one hinge on a bottom door portion.

Sixth, an individual would install the door panels by affixing them to the hinges 54. Typically, affixing the door panels would be done by screwing them into the hinges.

Those skilled in the art would understand that the steps above can be changed to achieve the same installation, or that certain steps may be skipped depending on the circumstances. For example, the shelf could be installed and affixed after the secured door portion is affixed. Or, the hinges may already be on the cabinet door from a prior installation of a convention cabinet door and would not need to be re-installed or moved. Further, the cabinet box may already be measured, and thus the door panels could be cut or made based on a known manufacturer tolerance or size measurement. Further, while the above steps 44-54 may relate to certain embodiments, it is understood and contemplated for the present invention that other embodiments of the present invention may also be installed pursuant to the above steps 44-54, with the changes and omissions contemplated by one skilled in the art.

Further embodiments than those described in the FIGS. 1-5 above are contemplated in the invention described herein. Generally, a secured storage space is useful for storing personal items, valuable items, or hazardous items. Additionally, there may be a secure storage space, with a secure space door portion 14 on each available cabinet box in the designated room being used in. Typical uses include storing pharmaceuticals, medical devices, medicaments, inhalers, prescription drugs, over-the-counter drugs, and formulations for regular or periodic use. Additional uses in embodiments may include storage of valuable personal items such as heirlooms, sentimental items, artwork, alcoholic beverages and bottles, rare or expensive food products or ingredients such as spices, government documents, travel documents, antiques, precious metals, jewelry, coins, collectable items, currency, cash, fine china, valuable utensils such as expensive knife sets or silver place settings, recipes, formulations, trade secrets, mail, packages, weapons, hardware, power tools, explosives, chemicals, toxic chemicals, cleaning products, and/or hazardous substances. Embodiments of the present invention are preferred to be utilized in typical kitchen cabinets, bathroom cabinets, garage cabinets, hospital cabinets, school cabinets, warehouse cabinets, office cabinets, and may be preferred for use in residential, commercial, industrial, medical, educational purposes and applications. Additionally, embodiments of the present invention may be used in stable settings, or also on movable or mobile items including carts or mobile storage systems used in pharmacies or hospitals.

In a typical embodiment, the locking mechanism 36 is a bolt or other length of metal, typically between ⅛″ or 1″ long that twists with the turn of a key or motorized rotor or pinion. In the locking position, the locking mechanism 36 is oriented to be spaced closely to, or adjacent to a portion of the cabinet box inside the secured storage space 30, or with some other portion affixed to said cabinet box to block the locking mechanism 36 from moving. Accordingly, the secured storage space door portion cannot be opened without changing the orientation of the locking mechanism 36. In certain embodiments, the locking mechanism 36 may require that the handle of the secured space door 28 is pressed firmly against the cabinet box to permit the locking mechanism 36 to be oriented to a locking position. In certain embodiments, the handle of the secured space door 28 may be integrated with the locking mechanism, and with a lock generally. In further embodiments, a single key entry portion could cause more than one locking mechanism 36 to change orientation. Additionally, more than one key entry portion may be required to cause at least one locking mechanism to change orientation, e.g., if a plurality of keys are required to open a secured space (whether physical or electronic keys). In certain embodiments, the secure space door locking mechanism 36 can be hidden inside of the cabinet and may be operated wirelessly by Wi-Fi through a downloadable application on a smartphone or other device. This would permit users to connect to the same Wi-Fi network to lock and unlock the lockable mechanism 36. Additionally, the app would notify a user of any tampering or forced entry of the secure space door 14.

In one embodiment, the pattern 20 on the top portion of the door may be formed of a material different than the door portion and may be affixed to the door panel. Additionally, the pattern 20 on the top portion of the door can also comprise paint or other color, or etchings, engravings, carvings, or other alterations to wood known in the art. Typically, the pattern 20 would match all portions of cabinet door and/or would also match the rest of the cabinet and other cabinets or storage spaces in the area so that the door to open the secured space would not be as conspicuous. The hinges of the door portions are typically made of metal, but other materials known in the art are also contemplated. Although depicted in the figures as rotating about a vertical axis, at least one or all hinges may rotate about a horizontal axis, or any other axis. The hinge portion affixed to the bottom portion of the door panel 24 is typically constructed of a heavy duty or grade of metal such as stainless steel. The means for affixing such a hinge 24 may also be a heavier grade or duty of steel or other metal than would be used for a non-secured portion. Additionally, a secured space door portion hinge 24 may be physically larger than a hinge portion used for a top portion of a door covering a non-secured storage portion 22, e.g., the hinge 24 may require a greater or heavier content of metal, or a higher density of metal, than the non-secured hinge 22. This permits improved security by preventing attacks to try to open the secured space using power tools or other forceful physical means aimed at disrupting, moving, or removing the hinge to gain access to the secured storage space. Further, for improved security, certain embodiments of the secured storage space portion may also include steel walls or walls of another hard or rigid or impermeable material to prevent unauthorized entry by drills or other forceful physical means. Such improved security measures are particularly preferred when particularly hazardous or dangerous items or chemicals, or particularly sought after pharmaceuticals are stored in the secured space, including without limitation firearms, narcotics, precious metals, jewelry, and currency.

In certain embodiments, there may be a plurality of secured space doors and non-secured space doors on a single cabinet, or on a single cabinet box or other storage container. The doors may be constructed of many different kinds of materials, e.g., wood, wood composite, stainless steel, aluminum, alloys, hard plastic, sheet metal, glass, frosted glass, stained glass. Although the figures generally depict embodiments of the invention where the door portions are stacked with one top of the other, other configurations are contemplated. As examples contemplated by the present invention, the secured door and accompanying secured space could be above the non-secured door; there could be at least one secured door on either side of at least one non-secured door; the door portions could be configured to align horizontally instead of vertically; at least one hinge could be configured to rotate on any axis to permit at least one door portion to open vertically or horizontally; and, at least one locking mechanism could secure a plurality of secure storage spaces.

In a particular embodiment, where relatively small quantities of pharmaceuticals are expected to be stored, the cabinet and the cabinet door portion for the secured space would be constructed of a heavy grade of steel providing improved security. Additionally, the cabinet box, shelf for the secured portion, and panels on all sides of the cabinet would be securely affixed to a wall or to a floor. In certain embodiments, a secure space door that is lockable would contain at least one, or a plurality of locking mechanisms which could selected from the following, including combination thereof: a keyed lock, digital key pad, Bluetooth activated electronic lock, nearfield communications activated electronic lock, fingerprint activated lock, retina recognition, and/or voice activation. This would permit improved security to prevent access to the secured space, and for electronic locking systems may permit a security system to detect improper attempts to access the secured storage space.

The door portions may be of variable sizes. In particular, the present invention contemplates doors for the secured storage space as having relatively small doors for narcotics, cough syrups, fire arms (particularly handguns or deconstructed long guns), mail, specialty spices useful for chefs such as exotic spices. In typical embodiments, such small doors for the secured storage space would be a square or rectangular door having a horizontal width of between 2 inches and 24 inches, and a vertical height of between 2 inches and 24 inches although other widths and heights are contemplated. Other, larger doors may be preferred for a larger size of secured storage space, and have a width of between 24 and 100 inches, and a length of between 24 and 100 inches. For a typical medicine secure storage cabinet the height of the door would be at least slightly larger than a typical medicine container, and would preferably be at least double the height of the tallest medicine container expected to be used. Generally, such a secure storage door when used for typical medications would be between about 3 inches to about 6 inches.

In certain embodiments, the secure space door 14 may contain several different moving portions with at least one of them being a lockable portion to create at least one secured space in the cabinet box. For a plurality of secured spaces, the plurality of lockable portions may permit each portion of the secure space door 14 to be lockable. Having multiple moving portions to the secure space door will allow more portions to be lockable. This will be useful in the case that there may be more than one person in the household that needs to lock away prescription drugs. It is very dangerous to store multiple people's prescription drugs together in the same place, and it can be deadly for someone to take the wrong drug.

In certain embodiments, through selection of at least one of, or a combination of, the placement of the locking system including the locking mechanism and key entry, and pattern matching of the door portions of the secured storage space system, the secured space storage system and its contents would be less visible to everyday users, which would help prevent to theft or other improper access. For example, people who would steal drugs from a cabinet, in many cases as a crime of opportunity, would not even have knowledge that the pharmaceuticals were in the house if they either could not determine that there existed a secured storage space, or could not determine or even guess what was inside of it. Generally, the only way an individual would know the contents of a secured space is if they are told that they are there or if they witness someone using them and placing them back in the secured space. Thus, in typical embodiments, the secure space storage system provides proper owners and users of pharmaceuticals with a way to both make others unaware of the presence of those pharmaceuticals at all, and further permits them to lock their prescriptions and over the counter drugs away from those not permitted to use or possess them. The secure storage space would stop from improper access at least the following types of individuals: infants, toddlers, children, adolescents, teens, kids, visitors, adults, burglars, thieves, and/or robbers.

In a certain embodiments of the invention, the secure storage space will contain theft or improper usage deterrence devices. For example, a weight sensor may be used to determine when pills are being removed from a container, and to monitor pill bottle weight as it reduces over time. In some embodiments, such a weight sensor is contemplated to be accurate to a resolution of at least one pill. The sensor device may be linked to Wi-Fi, the Internet, or to a broader network to alert users of an improper usage or removal of a pill. Additionally, theft deterrence may be achieved for certain individuals such as teens, who may figure out a passcode or the location of a key to gain entry to the secured space—certain weight sensor embodiments would still determine if more pills or if the weight of other medications, including fluids, improperly or unpredictably changed over time. Additionally, a weight sensor could also be used to reorder pills automatically through a connection to a pharmacy through the Internet when the weight is lowered to a certain threshold. In further embodiments, there may be sections or slots added to the secure space door 14 or inside the secure storage space 30 displaying the days of the week. As an example, the present invention contemplates using an insert to hold common pills or bottles. The insert may be further adjustable to hold any type of container or circular bottle. This would assist people that are using such an embodiment for their prescribed pharmaceuticals to properly keep up with and take their daily dosages. Further, the insert, or a portion of the secure door could have a pocket or sleeve attached to it, for important papers, insurance policies, cash, password lists, and other such items.

In typical embodiments the shelf 32 in the invention is a conventional removable or adjustable shelf made of wood or wood composite, or a metal. Generally, the shelf is an existing shelf, but may also be added to the cabinet using a material having the same or greater durability as the secure storage space door. In certain embodiments, a material with a greater durability than the secure storage space door is preferred for improved security because thieves may focus an attempt to steal medications on the openly accessible top or bottom of the shelf rather than on the door. Typically, such shelves come standard with a cabinet or cabinet kit, and any shelf may be utilized as the ceiling of a secure storage space. Additionally, custom shelves 32 may also be used. In certain embodiments, certain types of hardwoods (including without limitation oak, red oak, hickory, elm, mahogany, teak, beech, cherry), and/or heavy duty metal(s) may be selected to improve security. As described herein, the shelf is affixed to the cabinet box and may be affixed based on the desired space or volume of the secured storage space. In certain instances, a gap between the edge of the cabinet box or walls thereof and the shelf 32 may be preferable to improve or permit ventilation if it is desired for certain types of storage to either improve shelf life, or for safety. The cabinet door portion for the secured space, and the accompanying at least one hinge are configured so that when the door closes it is adjacent to, or nearly adjacent (i.e., with no or minimal gap) to the shelf. In some embodiments, the portion of the shelf and the cabinet door for the secured storage space may be affixed with at least one set of magnets that can facilitate the closing of the door to the shelf. In certain embodiments, the shelving can be installed at a custom height or angle to provide a ceiling for the secured storage space; in other embodiments, existing manufactured pegs or holes in the cabinet box may be utilized to secure the shelf 32. In still other embodiments, the shelf 32 could be generally horizontal as depicted in the Figures, but may also be a divider in embodiments where the secured storage space is configured horizontal to the non-secured space.

The present secure storage invention may be considered a significant cost savings device (or even a medical device subject to regulations governing the same) because of its ability to protect the medicines being prescribed to sick people. Generally, when a prescription of a drug is filled, the insurance company pays all but the co-pay for the medicine. However, every time someone steals opioids from a prescribed person that person ultimately has to go back to the pharmacy to get a new prescription filled. This action costs the insurance companies millions of dollars a year and the patient only has to pay a co-pay in most cases.

In further embodiments, the secure space door 14 can be designed with graphics, solid colors, water colors, laminate, wall paper, paint, each portion of door may or may not have knobs or handles 26, 28 on them, the doors could be lit up with LED lighting or tube lighting. Additionally, the secured space 30 could have a light on the inside so that users could find the right item and have the appropriate lighting to read the labels. Connecting portion of a cabinet between two doors, seamless design so security door is not visible. Typically knobs or handles 26, 28 are on a lower portion of a door front, but could be on a higher portion, or on a side portion, or on any edge of a door front. In certain embodiments, additional security is achieved by placing the knobs or handles at the top edge of a door front so that it is difficult for someone shorter such as a child or younger individual to open the door.

Certain embodiments of the present invention may be utilized in nursing home applications, or in other applications outside of the home environment. In nursing home applications, the invention permits a health professional to access a secure storage space in a resident's apartment, unit, room, or personal space to provide medications. This permits the resident to utilize the rest of the space in a cabinet for regular and daily usage. This is particularly important for some nursing home residents who may have memory or other cognitive issues that make access to their own medications dangerous because of the risk of improper dosing, or overdosing. For the theft prevention applications and embodiments of the invention, the secure storage space could be utilized by pharmacies and clinics to secure pharmaceuticals, particularly narcotics, controlled substances, expensive or rare drugs, or those that could be used to create or derive illegal drugs. In such an embodiment, theft could be prevented by employees or visitors to the pharmacy or clinic, and thus certain trusted members or managers of the pharmacy may be on the only individuals with access to the key or passcode or other entry mechanism for the secured storage space.

A person would use my invention to solve the problem of being able to securely lock medicines, opioids, narcotics, hazardous items, alcohol beverages, etc. away from children or adults that access needs to be prohibited from without giving up full accessibility to the entire cabinet box. The present invention allows all shelves above the secured lockable space to remain accessible for normal cabinet use.

The secure space door portion(s) may open from left to right, right to left, top to bottom, bottom to top. The portions may even be detachable and able to be exchanged with new door portions in case a portions door is broken into or damaged in any way. All portions may be able to lock together forming one solid door. The full solid door may then be locked using the locking mechanism on the lockable portion. An inner drawer may be able to slide out of the secured space once the lockable portion is unlocked and opened.

As required, detailed embodiments of the present invention are disclosed herein; however, while various embodiments and examples of this invention have been described above, these descriptions are given for purposes of illustration and explanation, and not limitation. Variations, changes, modifications, and departures from the systems, apparatus and methods disclosed above may be adopted without departure from the spirit and scope of this invention. Moreover, specific structural and functional details disclosed herein are not to be interpreted as limiting, but merely as a basis for the claims and as a representative basis for teaching one skilled in the art to variously employ the present invention. It will be apparent to those skilled in the art that many changes and substitutions may be made to the foregoing descriptions of preferred embodiments and examples without departing from the spirit and scope of the present invention, which is defined by the appended claims.

Further, the purpose of the Abstract is to enable the various patent offices and the public generally, and especially practitioners in the art such as carpenters, handymen, and those who construct cabinets or install similar structures in houses or offices, but who may not be familiar with patent or legal terms or phraseology, to determine quickly from a cursory inspection the nature and essence of the technical disclosure of the application. The Abstract is not intended to be limiting as to the scope of the invention in any way.

What is claimed is:

1. A cabinet in a room comprising:
a secure storage space with six barriers comprising: a cabinet door, a cabinet shelf forming a ceiling, a cabinet frame forming a floor and three sides;
wherein the cabinet door has a first selected vertical height, is installed after the installation of the cabinet in the room, and comprises a first durable material and a locking mechanism;
an unsecure storage space with six barriers comprising: a second cabinet door, the cabinet shelf forming a floor, and the cabinet frame forming a ceiling and three sides;
wherein the second cabinet door has a second selected vertical height, was installed at about the same time as the installation of the cabinet in the room, and comprises a second durable material;
wherein the cabinet door and the second cabinet door share a pattern;
wherein the contents of the secure storage space comprise at least one item that is at least either significantly valuable or significantly hazardous;
wherein the contents of the unsecure storage space consist of items that are neither significantly valuable nor significantly hazardous.

2. The cabinet of claim 1 wherein the cabinet door comprises an affixed knob near the locking mechanism.

3. The cabinet of claim 1 wherein the locking mechanism comprises steel and is operable by a metal key.

4. The cabinet of claim 1 wherein the top of the cabinet door and the bottom of the second cabinet door are separated by a gap of between 1 mm and 10 mm; wherein the pattern is incongruent with respect to the gap.

5. The cabinet of claim 1 wherein the cabinet shelf was installed at about the same time as the installation of the cabinet in the room.

6. The cabinet of claim 1 wherein the first durable material is a hardwood.

7. The cabinet of claim 6 wherein the hardwood is oak.

8. The cabinet of claim 7 wherein the cabinet shelf consists of material with a greater density than oak.

9. The cabinet of claim 1 wherein the first durable material has a greater density than the second durable material.

10. The cabinet of claim 1 further comprising at least one steel hinge affixed to the cabinet door, wherein the at least one steel hinge has a greater durability than any other hinge affixed to the cabinet.

11. The cabinet of claim 1 wherein the items of the unsecure storage space consist of items used for the regular functioning of the room.

12. The cabinet of claim 1 wherein the first selected vertical height is at least about 3 inches and wherein the second selected vertical height is at least about twice the height of the first selected vertical height.

13. The cabinet of claim 12 wherein the first selected vertical height is about 6 inches, and wherein the second selected vertical height is at least about 18 inches.

14. A cabinet in a kitchen comprising:
a secure storage space with six barriers comprising: a first wooden cabinet door, a wooden cabinet shelf forming a ceiling, and a wooden cabinet frame forming a floor and three sides;
wherein the first wooden cabinet door has a vertical dimension of about 6 inches, is installed after the installation of the cabinet in the kitchen, and comprises a metal locking mechanism, and either a knob or handle near the locking mechanism;
an unsecure storage space with six barriers comprising: a second wooden cabinet door, the wooden cabinet shelf forming a floor, and the wooden cabinet frame forming a ceiling and three sides;
wherein the second wooden cabinet door has a second selected vertical height, is installed after the installation of the cabinet in the kitchen, and comprises a second knob or handle;
wherein the contents of the secure storage space comprise at least one item that is at least either significantly valuable or significantly hazardous;
wherein the first wooden cabinet door and the second wooden cabinet door are separated by a gap of around 3 mm, share a pattern that is incongruent with respect to the gap, and comprise at least the same paint and molding pattern.

15. The cabinet of claim 14 wherein the contents of the secure storage space comprise prescription medications and over-the-counter medications, and wherein the contents of the unsecure storage space consist of items useful for the regular use of a kitchen.

16. The cabinet of claim 14 wherein:
the contents of the secure storage space comprise prescription medications, over-the-counter medications, and vitamins;
the contents of the unsecure storage space comprise plateware;
the knob or handle and the second knob or handle are made of metal;
the second selected vertical height is at least about 12 inches; and
the first wooden cabinet door and the second wooden cabinet door are made of oak.

17. A method of installing a secure storage space door on an existing kitchen cabinet in a family household comprising:
selecting a kitchen cabinet in a family household having at least one existing shelf wherein the bottom of a frame of the kitchen cabinet is located at least three feet above a kitchen floor;
removing a door from the kitchen cabinet;
removing at least one hinge from the kitchen cabinet;
selecting a flat piece of a durable material in about the same dimensions as the door;
selecting a height for a secured storage space wherein the height is less than half of the vertical dimension of the door, and affixing the shelf to the frame wherein the bottom of the shelf is at the selected height;
creating a pattern on the having four edges that are near the four edges of the piece, wherein said pattern is incongruent with the selected height, and wherein said pattern comprises molding, a color, and a selection of matte or gloss matching existing nearby kitchen cabinetry;
cutting the piece at said height and retaining a shorter piece and a longer piece;
restoring any blemish affecting the pattern following the cutting;
affixing a metal locking mechanism to the bottom of the cabinet;
affixing at least one steel hinge on a frame of said cabinet;
affixing the shorter piece to said at least one steel hinge;
affixing the longer piece to at least one hinge on the frame, wherein said longer piece is mounted to create a gap between the two piece of between about 1 mm to 5 mm.

18. The method of claim 17 wherein said height is between about 3 inches and about 6 inches, wherein said durable material is a hardwood; and wherein such piece is selected by measuring and cutting a piece of hardwood larger than the door.

19. The method of claim 17 wherein said locking mechanism comprises steel.

20. The method of claim 17 wherein the shorter piece is affixed vertically below the longer piece, the gap is about 3 mm, and the molding comprises a wood composite affixed to the piece.
